(19) United States
(12) Patent Application Publication
(10) Pub. No.: US 2021/0337887 A1
(43) Pub. Date: Nov. 4, 2021

(54) Mouth Shield

(71) Applicant: Kenneth S. Johnson, Tampa, FL (US)

(72) Inventor: Kenneth S. Johnson, Tampa, FL (US)

(21) Appl. No.: 16/862,190

(22) Filed: Apr. 29, 2020

(51) Int. Cl. A41D 1/00; A41D 13/11; A42B 3/30

(52) U.S. Cl. CPC A41D 1/002; A42B 3/30; A41D 13/11

(57) ABSTRACT

A mouth shield to prevent lip reading of the lips of a user may include a shield to shield the lips of the user; a pivoting fastener device to rotate the partial oval shield between a substantially horizontal position to a substantially vertical position in which the lips of the user substantially are uncovered to where the lips of the user are covered to prevent lip reading; and a clamp device to clamp the pivoting fastener device to a microphone.

### FIELD OF THE INVENTION

The present invention relates to protective shields and more particularly to a shield for the mouth (a mouth shield).

### BACKGROUND

Reading lips is an art which has limited uses today. However, reading lips in a sports environment has risen to a great need. A coach may need to communicate with team members or coaching staffs during a sports event. The information transmitted has great value to the members of the opposing team since this may give the opposing team a great advantage in knowing future plays or actions. Consequently there is a need to maintain the communications in secret and away from the opposing teams. They have tried in many ways to maintain these types of communications in secret. One way is to place an object in front of the mouth of a user such as a coach and block any attempt to read the lips of the user. This has many drawbacks. The object may not fully cover the lips of the user and the object may be unwieldy to keep the object available for when communication is necessary.

### SUMMARY

A mouth shield to prevent lip reading of the lips of a user may include a shield to shield the lips of the user; a pivoting fastener device to rotate the partial oval shield between a substantially horizontal position to a substantially vertical position in which the lips of the user substantially are uncovered to where the lips of the user are covered to prevent lip reading; and a clamp device to clamp the pivoting fastener device to a microphone.

The pivoting fastener device may include a pivoting arm to allow the partial oval shield to pivot between the vertical position and the horizontal position.

The pivoting fastener device may include a first support arm to connect to the pivoting arm at a first end of the first support arm.

The shield may be an oval shield.

The shield may be a rectangular shield.

The shield may be a square shield.

The shield may be a triangular shield.

The shield may be a circular shield.

A mouth shield to prevent lip reading of the lips of a user may include a shield to shield the lips of the user; a second support shaft which extends across a back surface of the shield and extends beyond the shield; and terminates in a hook which may be used to support the shield on a belt loop.

The second support shaft may be slidably connected to a sliding device.

The mouth shield may include a microphone attachment device to attach the mouth shield to a microphone

The microphone attachment device may include a base portion.

The microphone attachment device may include a pair of opposing upward extending arms to form a friction fit with the microphone.

The opposing upward extending arms may be flexible to form the friction fit with the microphone.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a back view of one embodiment of the mouth shield of the present invention.

FIG. 2 illustrates a perspective view of another embodiment of the mouth shield of the present invention.

FIG. 3 illustrates a perspective view of the other embodiment of the mouth shield of the present invention.

FIG. 4 illustrates a back view of the other embodiment of the mouth shield of the present invention.

FIG. 5 illustrates another back view of one embodiment of the mouth shield of the present invention.

FIG. 6 illustrates a triangular shield of the present invention.

FIG. 7 illustrates a circular shield of the present invention.

FIG. 8 illustrates a square shield of the present invention.

FIG. 9 illustrates a rectangular shield of the present invention.

FIG. 10 illustrates a oval shield of the present invention.

### DETAILED DESCRIPTION

The present invention provides a device to shield the lips of the user from being seen especially, by a person being positioned directly or near directly across from the user.

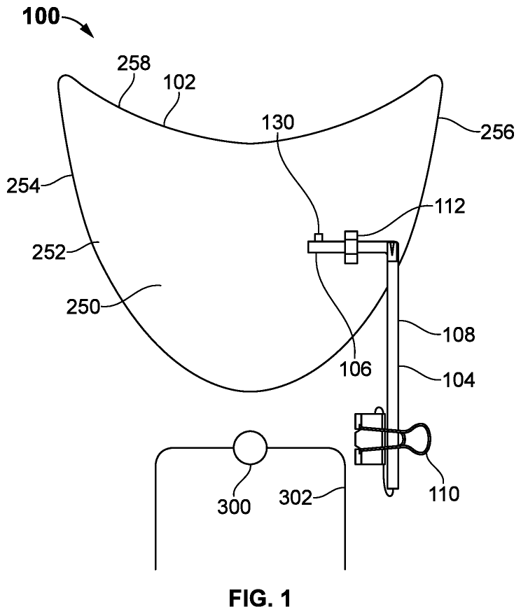

FIG. 1 illustrates a first embodiment of the invention including a mouth shield 100 including a partial oval shield 102 (which may be any shape including an complete oval, rectangle, square, triangle, circular shield), a pivoting fastener device 104 to allow the partial oval shield 102 to rotate substantially 180° and more particularly between a substantially horizontal position to a substantially vertical position in which the lips of the user substantially are uncovered to where the lips of the user are covered to prevent lip reading. The pivoting fastener device 104 may include a pivoting arm 106 to allow the partial oval shield 102 to pivot between the vertical position and the horizontal position and a first support arm 108 to pivotably connect to the pivoting arm 106 at one end of the first support arm 108. Additionally the pivoting fastener device 104 includes a clamp device 110 positioned at an opposing end of the first support arm 108 to clamp the first support arm 108 to microphone arm 302 of a microphone 300.

FIG. 1 additionally shows an attachment device 112 to attach or connect (pivotably) the pivoting arm 106 to the partial oval shield 102. As shown, the clamp device 110 may be a butterfly clamp device or other such device.

FIG. 1 shows the partially oval shield 102 having a substantially flat back surface 250 and a substantially flat front surface 252. The back surface 250 is connected to the front surface 252 by a first convex surface 254 and a second convex surface 256 and a concave surface 258.

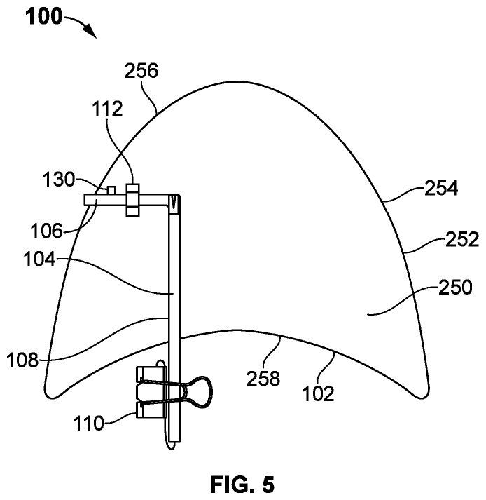

FIG. 5 illustrates another view of the mouth shield 100 with the partial oval shield 102 being rotated 180° from the position illustrated in FIG. 1.

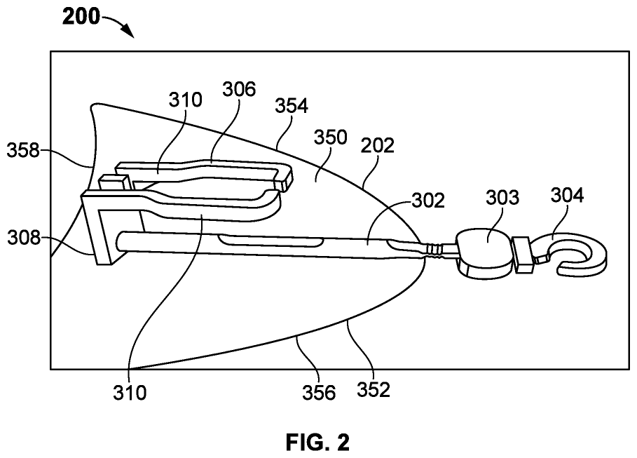

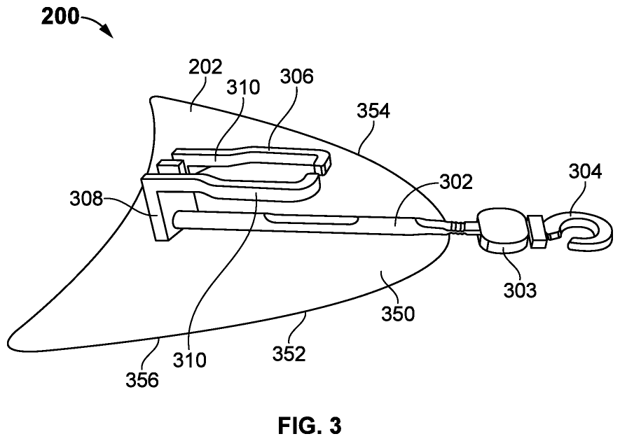

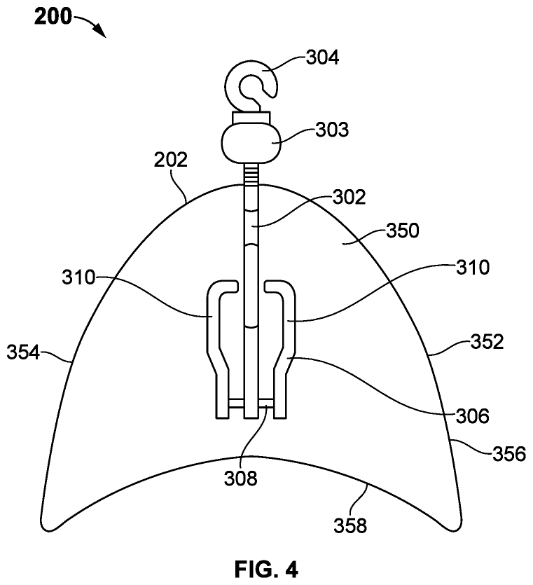

FIGS. 2-4 illustrate another embodiment of the mouth shield 200 of the present invention. The mouth shield 200 illustrates a partially oval shield 202 having a substantially flat back surface 350 and a substantially flat front surface 352. The back surface 350 is connected to the front surface 352 by a first convex surface 354 and a second convex surface 356 and a concave surface 358.

The mouth shield 200 additionally illustrates a second support shaft 302 which extends across the back surface 350 and extends beyond the mouth shield 200 and terminates in a hook 304 which may be used to support the mouth shield 200 on a belt loop (not shown) of the user providing a convenient way to store the mouth shield 200 when not in use. The second support shaft 302 may be slidably connected to a sliding device 303 which may travel in both directions along the second support shaft 302 and the distance between the hook 304 and the sliding device 302 to retain the mouth shield 200 on the belt loop

The mouth shield 200 additionally illustrates a microphone attachment device 306 to attach the mouth shield 200 to a microphone 300 (as shown in FIG. 1) and the microphone attachment device 306 having a base portion 308 and a pair of opposing upward extending arms which may be L-shaped to form a friction fit with the microphone 300.

The opposing end of the second support shaft 302 may terminate in the base portion 308, and the upward extending arms 310 may be sufficiently flexible to form the friction fit with the microphone 300 allowing the microphone to vary in size.

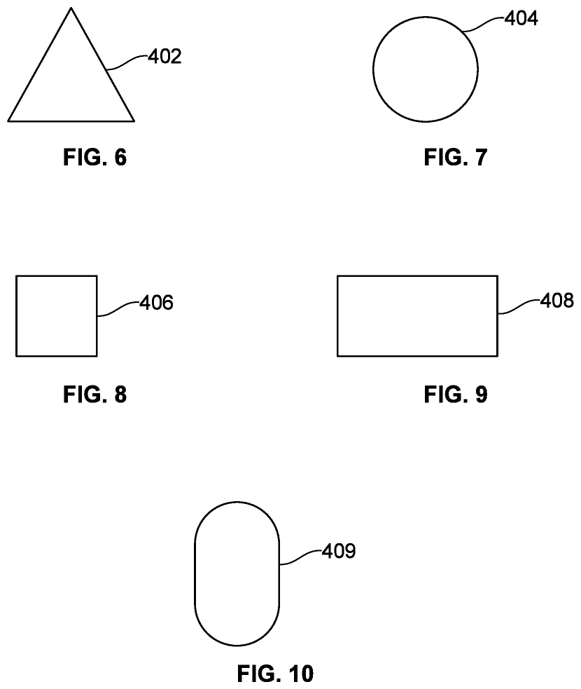

FIG. 6 illustrates a triangular shield 402.

FIG. 7 illustrates a circular shield 404.

FIG. 8 illustrates a square shield 406.

FIG. 9 illustrates a rectangular shield 408.

FIG. 10 illustrates an oval shield 410.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A mouth shield to prevent lip reading of the lips of a user, comprising:
a shield to shield the lips of the user;
a pivoting fastener device to rotate the partial oval shield between a substantially horizontal position to a substantially vertical position in which the lips of the user substantially are uncovered to where the lips of the user are covered to prevent lip reading;
a clamp device to clamp the pivoting fastener device to a microphone.

2) A mouth shield to prevent lip reading of the lips of a user as in claim 1, wherein the pivoting fastener device includes a pivoting arm to allow the partial oval shield to pivot between the vertical position and the horizontal position.

3) A mouth shield to prevent lip reading of the lips of a user as in claim 1, wherein the pivoting fastener device includes a first support arm to connect to the pivoting arm at a first end of the first support arm.

4) A mouth shield to prevent lip reading of the lips of a user as in claim 1, wherein the shield is an oval shield.

5) A mouth shield to prevent lip reading of the lips of a user as in claim 1, wherein the shield is a rectangular shield.

6) A mouth shield to prevent lip reading of the lips of a user as in claim 1, wherein the shield is a square shield.

7) A mouth shield to prevent lip reading of the lips of a user as in claim 1, wherein the shield is a triangular shield.

8) A mouth shield to prevent lip reading of the lips of a user as in claim 1, wherein the shield is a circular shield.

9) A mouth shield to prevent lip reading of the lips of a user, comprising:
a shield to shield the lips of the user;
a second support shaft which extends across a back surface of the shield and extends beyond the shield; and terminates in a hook which may be used to support the shield on a belt loop.

10) A mouth shield to prevent lip reading of the lips of a user as in claim 9, wherein the second support shaft is slidably connected to a sliding device.

11) A mouth shield to prevent lip reading of the lips of a user as in claim 10, wherein the mouth shield includes a microphone attachment device to attach the mouth shield to a microphone

12) A mouth shield to prevent lip reading of the lips of a user as in claim 11, wherein the microphone attachment device includes a base portion.

13) A mouth shield to prevent lip reading of the lips of a user as in claim 12, wherein the microphone attachment device includes a pair of opposing upward extending arms to form a friction fit with the microphone.

14) A mouth shield to prevent lip reading of the lips of a user as in claim 13 wherein the opposing upward extending arms are flexible to form the friction fit with the microphone.
